(19) United States
(12) Patent Application Publication
(10) Pub. No.: US 2026/0221026 A1
(43) Pub. Date: Jul. 30, 2026

(54) POSITION CALCULATION DEVICE, POSITION CALCULATION METHOD, AND PROGRAM STORAGE MEDIUM

(71) Applicant: NEC Corporation, Minato-ku, Tokyo (JP)

(72) Inventors: Eiichi TOKUMI, Tokyo (JP); Takuya HISAMOTO, Tokyo (JP); Kenichi KIJIMA, Tokyo (JP); Tetsuya TANABIKI, Tokyo (JP); Takahiro MIZUTA, Tokyo (JP); Takuya NOMURA, Tokyo (JP)

(73) Assignee: NEC Corporation, Minato-ku, Tokyo (JP)

(21) Appl. No.: 18/727,257

(22) PCT Filed: Mar. 25, 2022
(86) PCT No.: PCT/JP2022/014391

§ 371 Date: Jul. 8, 2024

(51) Int. Cl. G08C 21/00

(52) U.S. Cl. CPC G08C 21/00

(57) ABSTRACT

An acquisition unit of a position calculation device acquires identification information transmitted at a predetermined transmission timing by the autonomous vehicle. An identification information includes unique vehicle body information given to the autonomous vehicle, position information representing the position of the autonomous vehicle, and time information. A confirmation unit uses a predetermined standard movement pattern to select the most likely measured position as the position of the autonomous vehicle from among measured positions, which are the positions of the autonomous vehicle represented by the position information included in each of the plurality of pieces of identification information that have been acquired. The confirmation unit confirms the selected measured position as the position of the autonomous vehicle.

### TECHNICAL FIELD

The present invention relates to a technique for acquiring a flight position of an autonomous vehicle such as an autonomous aerial vehicle or an automatic driving vehicle.

### BACKGROUND ART

In logistics, infrastructure inspection, and the like, the use of autonomous aerial vehicles has become full-scale. The autonomous aerial vehicle herein is an airplane, a rotorcraft, a glider, an airship, or the like that can be used for aviation, and can be flown by remote control or automatic control. Such an autonomous aerial vehicle is also referred to as a drone, an unmanned aerial vehicle (UAV), or the like.

Efforts have been made by the country to achieve such an autonomous aerial vehicle flying out of sight, and as one of them, vehicle body registration for the autonomous aerial vehicle is mandated from June 2022. Based on the rules associated with this, information called remote identification (ID) is transmitted from the flying autonomous aerial vehicle by wireless communication. The remote ID includes unique vehicle body information (aircraft registration number), position information, and time information.

Patent Literature 1 (JP 2018-165931 A) discloses a technique for controlling the flight of a drone to be controlled using state information (information including identification information and current position information of the drone) transmitted from the drone flying in an airspace to be managed.

### CITATION LIST

### Patent Literature

PTL 1: JP 2018-165931 A

### SUMMARY OF INVENTION

### Technical Problem

Since the remote ID transmitted from the autonomous aerial vehicle includes the position information indicating the flight position of the autonomous aerial vehicle, it is conceivable to perform the flight management of the autonomous aerial vehicle to be managed using the flight position based on the remote ID.

However, the position information included in the remote ID has the following problems. That is, the position information is, for example, position information acquired by the autonomous aerial vehicle using a global navigation satellite system (GNSS) such as a global positioning system (GPS). That is, the autonomous aerial vehicle receives a radio wave transmitted from a GNSS satellite, and the autonomous aerial vehicle acquires (calculates) position information using information included in the radio wave. The position information acquired in this manner includes an error caused by a reception state of radio waves from a GNSS satellite or the like. Since the reception state of the radio wave received by the autonomous aerial vehicle from the GNSS satellite changes depending on the surrounding environment (for example, the weather and the presence or absence of a high building) of the autonomous aerial vehicle and the like, the error included in the position information acquired by the autonomous aerial vehicle varies. As a result, the positional precision of the positional information included in the remote ID varies.

Since the positional precision varies as described above, it is difficult to correct the position information included in the remote ID, and if the position information included in the remote ID is acquired as it is as the flight position of the autonomous aerial vehicle, it is considered that a situation in which the position information is deviated from the actual flight position frequently occurs. In consideration of utilizing the autonomous aerial vehicle for logistics, for example, flight in a limited airspace such as above a road is also assumed. In such a case, a deviation amount between the flight position acquired from the position information of the remote ID and the actual flight position cannot be ignored. That is, if the flight position based on the position information included in the remote ID is directly used for flight management of the autonomous aerial vehicle, there is a possibility that smooth flight management of the autonomous aerial vehicle cannot be achieved. It is considered that such a problem may also occur when operation management of an autonomous vehicle is performed using position information transmitted from the autonomous vehicle such as an unmanned driving (automatic driving) vehicle that transmits position information by GNSS or the like.

The present invention has been devised in order to solve the above problems. That is, a main object of the present invention is to provide a technique for improving the calculation precision of the position of the autonomous vehicle calculated using the position information transmitted from the autonomous vehicle including the autonomous aerial vehicle.

### Solution to Problem

In order to achieve the above object, a position calculation device according to an aspect of the present invention includes
an acquisition unit for acquiring identification information transmitted from an autonomous vehicle that transmits the identification information at predetermined transmission timings, the identification information including unique vehicle body information given to the autonomous vehicle, position information indicating a position of the autonomous vehicle, and time information, and
a confirmation unit for selecting a measured position likely to be a position of the autonomous vehicle using a standard movement pattern provided in advance from among measured positions which are positions of the autonomous vehicle indicated by the position information included in each of a plurality of pieces of the acquired identification information, and confirming the selected measured position as a position of the autonomous vehicle.

A position calculation method according to an aspect of the present invention causes a computer to execute
acquiring identification information transmitted from an autonomous vehicle that transmits the identification information at predetermined transmission timings, the identification information including unique vehicle body information given to the autonomous vehicle, position information indicating a position of the autonomous vehicle, and time information, and
selecting a measured position likely to be a position of the autonomous vehicle using a standard movement pattern provided in advance from among measured positions that are positions of the autonomous vehicle indicated by the position information included in each of a plurality of pieces of the acquired identification information, and confirming the selected measured position as a position of the autonomous vehicle.

A program storage medium according to an aspect of the present invention
stores a computer program for causing a computer to execute
acquiring identification information transmitted from an autonomous vehicle that transmits the identification information at predetermined transmission timings, the identification information including unique vehicle body information given to the autonomous vehicle, position information indicating a position of the autonomous vehicle, and time information, and
selecting a measured position likely to be a position of the autonomous vehicle using a standard movement pattern provided in advance from among measured positions that are positions of the autonomous vehicle indicated by the position information included in each of a plurality of pieces of the acquired identification information, and confirming the selected measured position as a position of the autonomous vehicle.

### Advantageous Effects of Invention

According to the present invention, it is possible to improve the calculation precision of the position of an autonomous vehicle calculated using the position information transmitted from the autonomous vehicle including the autonomous aerial vehicle.

### BRIEF DESCRIPTION OF DRAWINGS

FIG. 1 is a diagram for explaining a configuration of a position calculation device according to a first example embodiment of the present invention.

FIG. 2 is a diagram for explaining an operation management system in which an operation management device including the position calculation device according to the first example embodiment is incorporated.

FIG. 3 is an image diagram illustrating a flight position (measured position) of the autonomous aerial vehicle based on position information included in a remote ID transmitted from the autonomous aerial vehicle.

FIG. 4 is a diagram for explaining a method in which the position calculation device of the first example embodiment calculates a flight position of an autonomous aerial vehicle using position information included in a remote ID.

FIG. 5 is a diagram for explaining a method in which the position calculation device of the first example embodiment calculates the flight position of the autonomous aerial vehicle using the position information included in the remote ID.

FIG. 6 is an image diagram illustrating an example of a flight position and a flight trajectory of the autonomous aerial vehicle calculated by the position calculation device of the first example embodiment.

FIG. 7 is a flowchart illustrating an example of an operation in which the position calculation device of the first example embodiment calculates a flight position of the autonomous aerial vehicle using position information included in the remote ID.

FIG. 8 is a diagram for explaining a configuration of a position calculation device according to a second example embodiment.

FIG. 9 is a diagram for explaining an example embodiment in which a position calculation device is incorporated in a monitoring device.

FIG. 10 is a diagram for explaining a configuration of a position calculation device according to another example embodiment.

FIG. 11 is a flowchart illustrating an example of an operation of a position calculation device according to another example embodiment.

### EXAMPLE EMBODIMENT

Hereinafter, an example embodiment according to the present invention will be described with reference to the drawings.

### First Example Embodiment

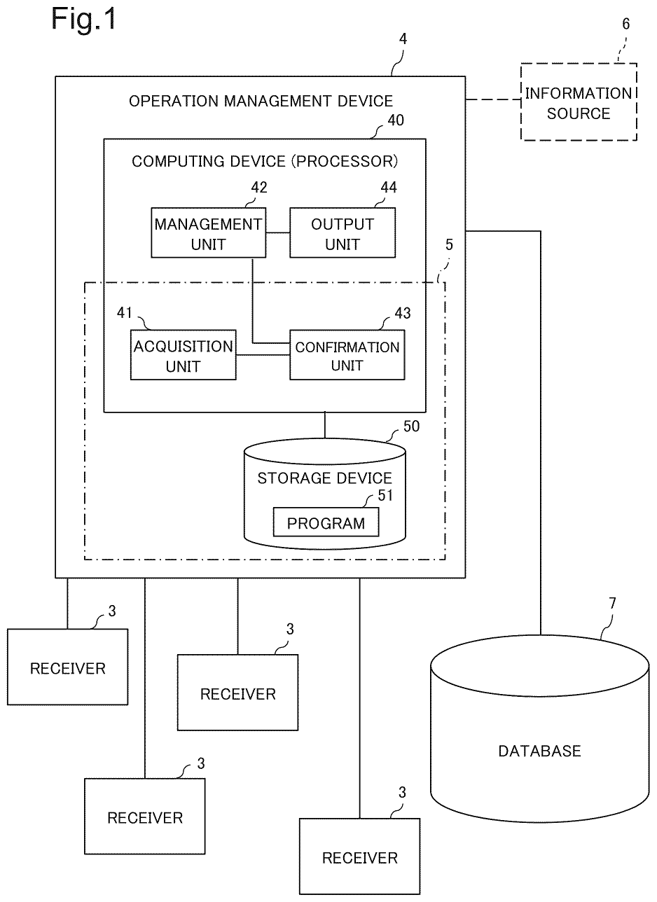

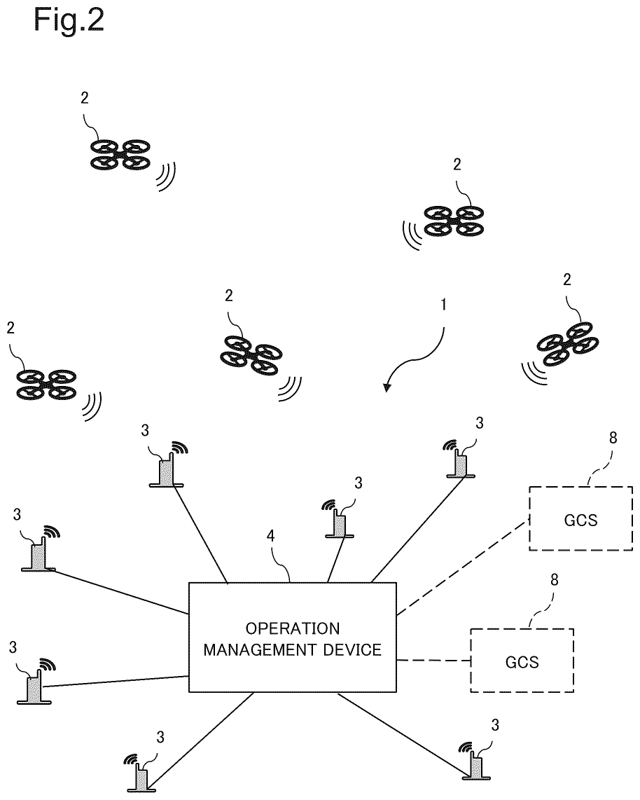

FIG. 1 is a diagram for explaining a configuration of an operation management device including a position calculation device according to a first example embodiment of the present invention. An operation management device 4 is a computer device that is incorporated in an operation management system 1 as illustrated in FIG. 2 and manages the operation of an autonomous aerial vehicle 2. Here, the autonomous aerial vehicle 2 has a structure that can be used for aviation, and can be flown by remote control or automatic control, and includes a so-called drone or a flying vehicle. The autonomous aerial vehicle 2 transmits a remote ID by wireless communication at predetermined timing (for example, every one second). The remote ID is identification information for identifying the autonomous aerial vehicle 2 in flight, and includes unique vehicle body information, position information, and time information. The unique vehicle body information is information including a unique airframe number given to each autonomous aerial vehicle 2, and here, a registration number issued (given) by registering a vehicle body in the country is included as a unique vehicle body number. The position information is information (for example, latitude, longitude, and height information) indicating a flight position of the autonomous aerial vehicle 2 acquired using a global navigation satellite system (GNSS). The time information is information indicating the time at which the information indicating the flight position in the position information has been acquired. Such unique vehicle body information, position information, and time information are associated with each other and included in the remote ID. Bluetooth (registered trademark) is used as the wireless communication method of the remote ID, for example. The autonomous aerial vehicle 2 as described above is a type of autonomous vehicle. Here, the autonomous vehicle is a device such as an autonomous aerial vehicle or an automatic driving vehicle in which a pilot or a driver is not on and which moves by remote control or autonomous control, and has a function of transmitting position information for remote control or operation management.

The operation management system 1 includes a plurality of receivers 3 and an operation management device 4. The receiver 3 has a function of receiving a remote ID transmitted from the autonomous aerial vehicle 2 and a function of transmitting the received remote ID to the operation management device 4. The configuration of the receiver 3 is not limited as long as the receiver 3 has a configuration capable of receiving a remote ID and capable of being connected to the operation management device 4 via an information communication network, and the description thereof is omitted here. The receiver 3 described above is installed at a plurality of places determined in consideration of a predetermined route of the autonomous aerial vehicle 2. Some of the plurality of receivers 3 constituting the operation management system 1 may be mounted on a moving body. That is, the receiver 3 may be mounted on a vehicle such as a truck as an on-vehicle device, or a processor that executes processing according to an application program and the receiver 3 achieved by a communication device may be provided in a computer device or a mobile terminal of a car navigation system.

As illustrated in FIG. 1, the operation management device 4 includes a computing device 40 and a storage device 50. The storage device 50 includes a storage medium that stores data and a computer program (hereinafter, also referred to as a program) 51.. There is a plurality of types of storage devices such as a magnetic disk device and a semiconductor memory element, and there are a plurality of types of semiconductor memory elements such as a random access memory (RAM) and a read only memory (ROM). The type of the storage device 50 included in the operation management device 4 is not limited to one. A computer device is often provided with a plurality of types of storage devices. Here, the type and number of storage devices 50 provided in the operation management device 4 are not limited, and the description thereof will be omitted. In a case where a plurality of types of storage device 50 are provided in the operation management device 4, they are collectively referred to as a storage device 50.

The storage device 50 stores a computer program for causing the operation management device 4 to have a function of performing flight management of the autonomous aerial vehicle 2, a computer program for calculating a flight position of the autonomous aerial vehicle 2 from position information included in the remote ID, and the like.

The computing device 40 includes a processor such as a central processing unit (CPU) or a graphics processing unit (GPU). The computing device 40 can have various functions based on a program 51 by reading and executing the program 51 stored in the storage device 50. Here, the computing device 40 includes an acquisition unit 41, a management unit 42, a confirmation unit 43, and an output unit 44 as functional units. In the first example embodiment, a position calculation device 5 is provided in the operation management device 4, and includes the acquisition unit 41, the confirmation unit 43, and the storage device 50 of the computing device 40 constituting the operation management device 4.

The acquisition unit 41 has a function of acquiring the remote ID received by the receiver 3 from the autonomous aerial vehicle 2 from each of the receivers 3. The information included in the received remote ID is associated with each other, and is held in the storage device 50 in a state in which, for example, receiver identification information for identifying the receiver 3 that has transmitted the information is further associated.

The confirmation unit 43 confirms, as a flight position of the autonomous aerial vehicle 2, a measured position that is likely to be an actual flight position from among position information (hereinafter, also referred to as a measured position) of a plurality of remote IDs transmitted from the same autonomous aerial vehicle 2 in flight and acquired by the acquisition unit 41. Since the flight position of the autonomous aerial vehicle 2 determined by the confirmation unit 43 is used for flight management of the autonomous aerial vehicle 2 in flight by the management unit 42, the confirmation of the flight position is sequentially executed at appropriate timings during the flight of the autonomous aerial vehicle 2.

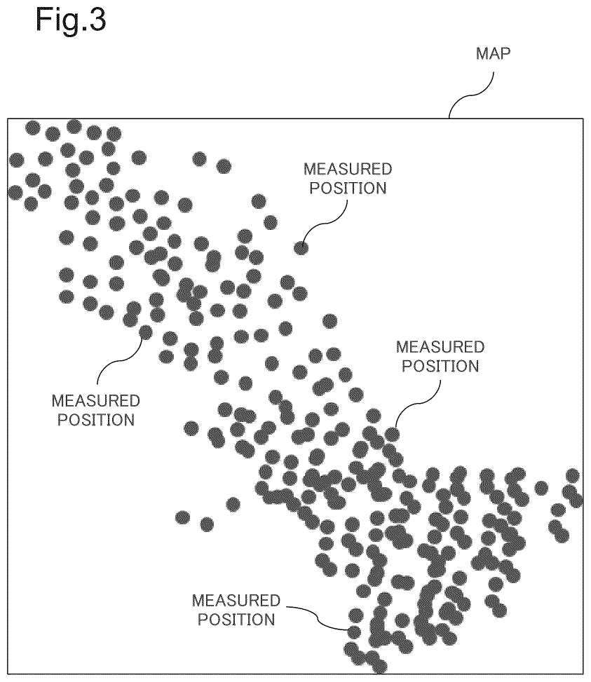

That is, as described above, the position information (measured position) of the remote ID transmitted from the autonomous aerial vehicle 2 includes an error, and the measured position varies because the error varies. FIG. 3 is an image diagram in which position information (measured position) of the remote ID transmitted from the same autonomous aerial vehicle 2 is represented by a point (●) on a map. In the image diagram of FIG. 3, since the measured positions are represented on the map, the plurality of measured positions appear to be located on the same plane along the ground, but the plurality of measured positions also vary in the height direction with respect to the ground.

As described above, there is a problem that it is difficult to acquire a correct flight position and a correct flight trajectory of the autonomous aerial vehicle 2 if the measured positions are used as they are due to variations in the measured positions related to the same autonomous aerial vehicle 2.

Therefore, in the first example embodiment, the confirmation unit 43 confirms (calculates) the flight position of the autonomous aerial vehicle 2 as follows. That is, the flight plan and the route reference information of the autonomous aerial vehicle 2 are stored in advance in the storage device 50 or a database 7 connected to the operation management device 4. The route reference information is information including information on a standard route pattern (movement pattern) of the autonomous aerial vehicle 2. The information on the standard route pattern is information indicating a route pattern that is likely to be the autonomous aerial vehicle generated by processing a large number of flight trajectories based on the actual flight position of the autonomous aerial vehicle 2 measured using, for example, an image of a radar or a camera by, for example, statistical processing or artificial intelligence (AI). In order to generate the standard route pattern, the flight speed of the autonomous aerial vehicle 2, information on the weather of the airspace where the autonomous aerial vehicle 2 has flown, information on the time when the autonomous aerial vehicle 2 has flown, and the like may also be used. In this case, for example, information for calculating a standard route pattern using the flight speed of the autonomous aerial vehicle 2, information on the weather of the airspace where the autonomous aerial vehicle 2 has flown, and information on the time when the autonomous aerial vehicle 2 has flown may be included in the route reference information as the information on the standard route pattern.

The information of the standard route pattern included in the route reference information stored in the storage device 50 or the database 7 is not limited to one, and for example, information of a plurality of standard route patterns relevant to a plurality of models of the autonomous aerial vehicle 2 may be included. Information of a plurality of standard route patterns relevant to each of weather such as sunny, strong, and rainy may be included in the route reference information. Information on a plurality of standard route patterns relevant to a plurality of combinations of such models and weather may be included in the route reference information.

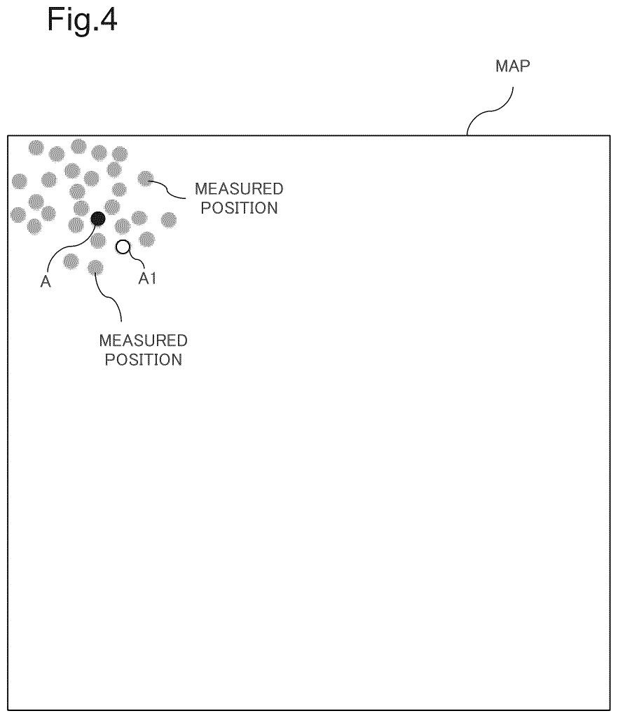

Here, for example, with respect to one autonomous aerial vehicle 2 (hereinafter, also referred to as a target vehicle body), it is assumed that the confirmation unit 43 focuses on one (also referred to as a focused position A) of the measured positions of a plurality of remote IDs as illustrated in FIG. 4 transmitted from the target vehicle body. It is assumed that the focused position A is a position that is likely to be a flight position of the target vehicle body.

Then, the confirmation unit 43 refers to the standard route pattern and the flight plan of the target vehicle body as described above, and selects a measured position (for example, a measured position A1 in FIG. 4) that is likely to be a flight position at which the target vehicle body has advanced from the focused position A, from among a plurality of measured positions (selection candidates) associated with the unique vehicle body information of the target vehicle body. That is, the target vehicle body (autonomous aerial vehicle 2) tries to fly according to the flight route included in the flight plan, but actually, there is a case where the target vehicle body deviates from the flight route due to wind conditions in the flight airspace or the like. For this reason, here, not only the flight plan but also the standard route pattern is used to select a measured position that is likely to be the flight position of the target vehicle body.

The confirmation unit 43 confirms the selected measured position A1 as the flight position of the target vehicle body. The measured position that is likely to be the flight position is, for example, a measured position within a range determined with reference to the focused position A as a selection candidate, and is selected from among the measured positions of the selection candidate. Examples of the range for determining the selection candidate include a range determined by a direction in which the target vehicle body is assumed to move forward from the reference (focused position A) and a distance (in other words, a speed of the target vehicle body) in which the target vehicle body is assumed to move forward from the reference (focused position A) in a predetermined time. The standard route pattern to be referred may be a route pattern in which the flight speed of the target vehicle body and the weather of the flight airspace are considered. That is, as described above, in a case where the information on the flight speed of the autonomous aerial vehicle 2 and the plurality of standard route patterns relevant to each of the weather such as sunny, strong, and rainy is included in the route reference information, the flight speed of the autonomous aerial vehicle 2 and the route pattern relevant to the weather of the flight airspace are referred to.

The following correction of the measured position may be performed before selecting the measured position as described above. That is, the surrounding environment (environment such that there is a higher build nearby, that there is a large river, and that there is a place half-way up to a mountain) in which the receiver 3 is installed can also be said to be an environment in which the autonomous aerial vehicle 2 whose remote ID is acquired by the receiver 3 is flying. Therefore, it is considered that the position information included in the remote ID received by the receiver 3 includes an error according to the radio wave reception situation of the autonomous aerial vehicle 2 caused by the environment around the receiver 3 (the environment around the autonomous aerial vehicle 2). In a case where the main factor of the error of the position information is an error caused by the environment as described above, for example, it is conceivable that a similar positional deviation is found in the position information of the received remote ID depending on the receiver 3. That is, it is conceivable that the position information of the remote ID received by a certain receiver 3 has a positional deviation such as a tendency to deviate by about 700 meters in the west direction from the actual position of the autonomous aerial vehicle 2 depending on the receiver 3. In consideration of this, with respect to the position information (measured position) of the remote ID received by the receiver 3 in which such a position deviation that can be estimated in advance is found, the amount of the estimated position deviation is corrected.. The measured position selection processing as described above may be executed using the corrected measured position thus corrected.

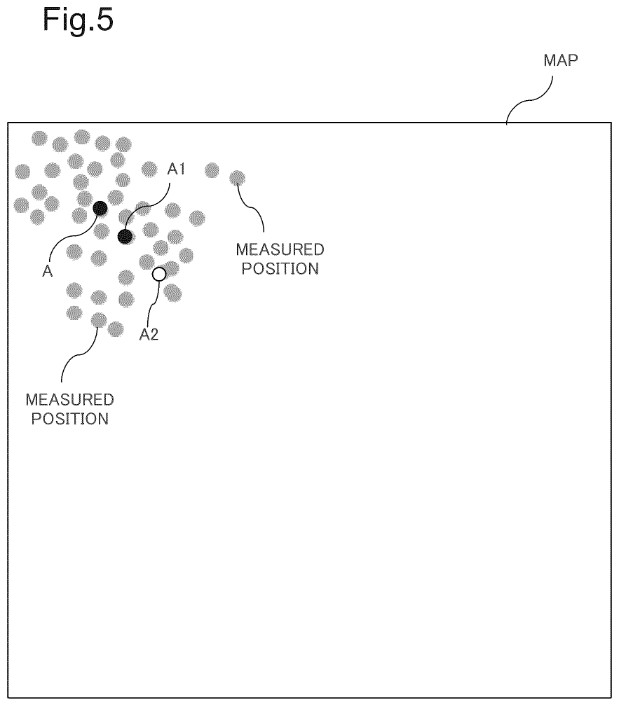

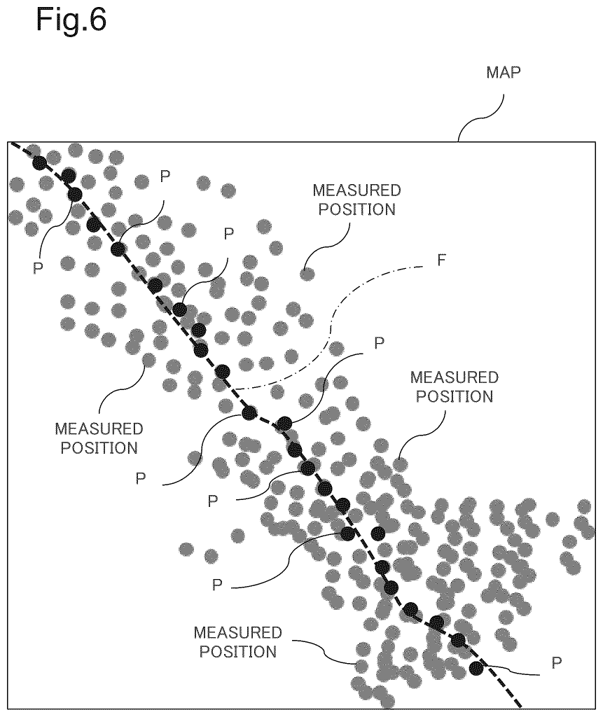

The confirmation unit 43 repeats the above similar processing with the confirmed flight position (measured position A1) as a focused position, selects, for example, a measured position A2 as illustrated in FIG. 5 as a likely flight position of the target vehicle body, and confirms the measured position A2 as the flight position of the target vehicle body. By repeating such processing at each predetermined processing start timing, the confirmation unit 43 sequentially confirms a likely flight position P of the target vehicle body as illustrated in FIG. 6 as the flight position of the target vehicle body. The processing start timing may be, for example, a timing at which the number of acquired measured positions is counted and the counted number reaches a set number, a timing at which the measured positions are acquired (that is, every time a measured position is acquired), or every set time interval.

The information on the likely flight position of the target vehicle body confirmed as described above is stored in the storage device 50 or the database 7 as the confirmed flight position information in association with the unique vehicle body information of the target vehicle body and the time information associated with the position information relevant to the confirmed flight position.

The confirmation unit 43 uses the confirmed flight position P of the target vehicle body and the time information associated with the position information relevant to the flight position P to calculate a flight trajectory (hereinafter, also referred to as an estimated trajectory) of the target vehicle body as indicated by a dotted line F in FIG. 6, for example. The information of the calculated estimated trajectory of the target vehicle body is stored in the storage device 50 or the database 7 in association with the unique vehicle body information of the target vehicle body and the information of the flight date and time. In a case where the estimated trajectory of the target vehicle body is calculated and the flight position P of the target vehicle body is newly confirmed, the confirmation unit 43 updates the estimated trajectory of the target vehicle body in consideration of the new flight position P. The information on the estimated trajectory of the target vehicle body after the update is overwritten and stored in the storage device 50 or the database 7.

In a case where the acquisition unit 41 acquires the remote IDs of the plurality of autonomous aerial vehicles 2, the confirmation unit 43 selects a likely flight position from among the plurality of measured positions as described above for each of the autonomous aerial vehicles 2, and confirms the selected position as the flight position of the autonomous aerial vehicle 2. The confirmation unit 43 calculates a flight trajectory (estimated trajectory) for each autonomous aerial vehicle 2 using the confirmed flight position.

The management unit 42 performs flight management of the autonomous aerial vehicle 2 to be managed using the confirmed flight position information including the flight position of the autonomous aerial vehicle 2 confirmed by the confirmation unit 43. The output unit 44 outputs a result of processing by the management unit 42 from the computing device 40 to a preset output destination.

While the processing executed by the management unit 42 includes various types of processing, an example of processing related to the flight management will be described here.

For example, information on the flight plan of the autonomous aerial vehicle 2 to be managed is stored in advance in the storage device 50 or the database 7 to which the operation management device 4 is connected. For example, the unique vehicle body information of the autonomous aerial vehicle 2 that executes the flight plan is associated with the information of the flight plan. Instead of the unique vehicle body information (that is, the registration number given by the country), a vehicle body identification number unique to the system given to the autonomous aerial vehicle 2 by the operation management system 1 to identify the autonomous aerial vehicle 2 may be associated with the flight plan. In such a case, for example, data indicating a correspondence relationship between the vehicle body identification number and the unique vehicle body information (registration number) is held in the storage device 50.

Using the unique vehicle body information of the remote ID acquired by the acquisition unit 41, the management unit 42 refers to the flight plan of the autonomous aerial vehicle 2 relevant to the unique vehicle body information in the storage device 50 or the database 7. Then, the management unit 42 compares the confirmed flight position information and the information of the flight trajectory (estimated trajectory) by the confirmation unit 43 with the flight route (hereinafter, also referred to as a planned route) and the scheduled flight time included in the flight plan, and determines whether the autonomous aerial vehicle 2 is flying according to the flight plan. For example, the management unit 42 calculates a deviation amount in which the estimated trajectory by the confirmation unit 43 is deviated from the planned route, and determines whether the deviation amount is within a predetermined allowable range. As a result of this determination, in a case where it is detected that the flight deviates from the planned route beyond the allowable range, the management unit 42 executes predetermined coping processing. As the coping processing, for example, in a case where the management unit 42 (operation management device 4) can directly control the autonomous aerial vehicle 2, the management unit 42 executes the flight control of the autonomous aerial vehicle 2 deviating from the planned route in order to correct the flight route. In this case, the output unit 44 outputs a control signal toward the autonomous aerial vehicle 2 to be flight-controlled.

The operation management device 4 performs flight management of the autonomous aerial vehicle 2 to be managed, and flight control (operation) of the autonomous aerial vehicle 2 may be executed by a ground control system (ground control station (GCS)) different from the operation management device 4. In this case, the operation management device 4 is connected to a GCS 8 as indicated by a dotted line in FIG. 2 that performs flight control (operation) of the autonomous aerial vehicle 2 to be managed. The management unit 42 may notify the GCS 8 controlling the autonomous aerial vehicle 2 deviating from the planned route of information deviating from the planned route by the output unit 44. In such a case, data in which the autonomous aerial vehicle 2 to be managed and information (including connection destination information) representing the GCS 8 that controls the autonomous aerial vehicle 2 are associated with each other is held in the storage device 50 or the database 7.

The management unit 42 detects the autonomous aerial vehicle 2 flying within a notification range determined based on the flight position of the autonomous aerial vehicle 2 deviated from the planned route using the confirmed flight position information by the confirmation unit 43 for each autonomous aerial vehicle 2. Then, the management unit 42 may notify the GCS 8 performing the flight control of the detected autonomous aerial vehicle 2 of information indicating that the autonomous aerial vehicle 2 deviating from the planned route is flying nearby by the output unit 44. Incidentally, it is assumed that there is a case where the remote ID transmitted from the autonomous aerial vehicle 2 other than the management target is included in the large number of remote IDs acquired by the acquisition unit 41 from the receiver 3. Here, for example, it is assumed that a database of a system related to registration of an autonomous aerial vehicle such as a drone information platform system (DIPS (Drone/UAS Information Platform System)) is an information source 6 as indicated by a dotted line in FIG. 1 and can be connected to the operation management device 4. It is assumed that the operation management device 4 can acquire information on a pilot or the like of the autonomous aerial vehicle from the information source 6. In this case, the management unit 42 can acquire information of a contact address (connection destination) of the pilot (GCS) associated with the remote ID transmitted from the autonomous aerial vehicle 2 other than the management target. As a result, the management unit 42 may also notify a pilot (GCS) performing flight control of the autonomous aerial vehicle 2 other than the autonomous aerial vehicle 2 to be managed of information indicating that the autonomous aerial vehicle 2 deviating from the planned route is flying nearby.

For example, the management unit 42 may notify a control center of a manned aerial vehicle determined in advance by the output unit 44, a nearby facility, or the like of information notifying that there is the autonomous aerial vehicle 2 deviated from the planned route and a flight position thereof, as another coping processing.

The coping processing in a case where the autonomous aerial vehicle 2 to be managed deviates from the planned route includes various types of processing including the above-described example, and here, the coping processing executed by the management unit 42 is not limited.

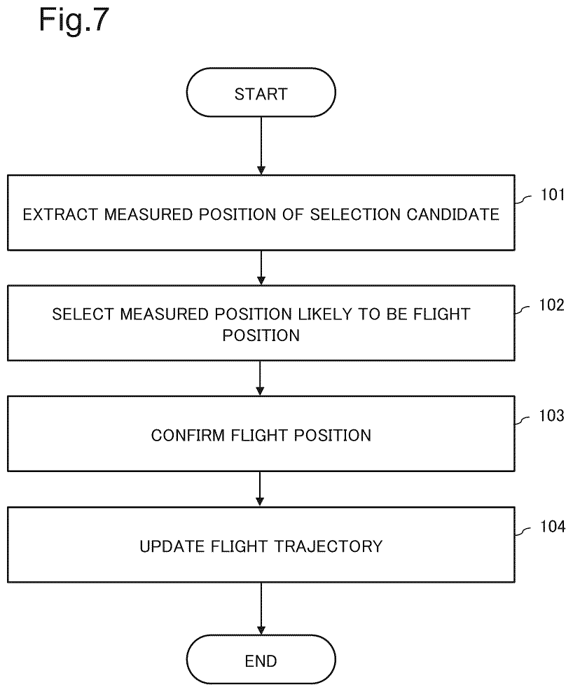

Hereinafter, an example of the operation of the position calculation device 5 in the operation management device 4 will be described with reference to FIG. 7. FIG. 7 is a flowchart for explaining an example of the operation of the position calculation device 5. For example, it is assumed that the acquisition unit 41 acquires the remote ID from the receiver 3 every moment, and information of a plurality of measured positions based on the remote ID from the target vehicle body is stored in the storage device 50 or the database 7. In such a state, when the confirmation unit 43 detects that the processing start timing has come, the confirmation unit extracts the measured position of the selection candidate related to the target vehicle body from the measured positions stored in the storage device 50 or the database 7 (step 101 in FIG. 7).

Then, the confirmation unit 43 refers to the standard route pattern and the flight plan of the autonomous aerial vehicle 2, selects a measured position that is likely to be the flight position of the target vehicle body from among the measured positions of the selection candidates (step 102), and confirms the selected measured position as the flight position of the aircraft of interest (step 103). As the confirmed flight position information, the information of the confirmed flight position is stored in the storage device 50 or the database 7 in association with the unique vehicle body information of the target vehicle body and the time information associated with the position information relevant to the confirmed flight position.

The confirmation unit 43 updates the flight trajectory of the target vehicle body in consideration of the confirmed flight position (step 104), and the updated flight trajectory is overwritten and stored in the storage device 50 or the database 7.

The position calculation device 5 of the first example embodiment refers to a standard route pattern and a flight plan obtained in advance, selects a measured position that is likely to be the flight position of the autonomous aerial vehicle 2 from among the measured positions, and confirms the selected position as the flight position of the autonomous aerial vehicle 2. As a result, the position calculation device 5 can calculate the flight position of the autonomous aerial vehicle 2 in which the adverse effect of the deviation in the measured position caused by the deviation in the error is suppressed. That is, the position calculation device 5 can improve the precision of the flight position of the autonomous aerial vehicle 2 calculated using the position information included in the remote ID.

The operation management device 4 performs flight management of the autonomous aerial vehicle 2 using the flight position and the flight trajectory of the autonomous aerial vehicle 2 confirmed (calculated) by the position calculation device 5 (confirmation unit 43), and thus, it is possible to suppress the occurrence of a problem caused by the precision of the position information of the remote ID.

The confirmation unit 43 may further include the following functions. That is, it is conceivable that a flight section in which the remote ID of the autonomous aerial vehicle 2 is not acquired occurs even though the autonomous aerial vehicle 2 is flying. In such a case, the confirmation unit 43 may refer to the standard route pattern (movement pattern) and the flight plan to estimate the flight trajectory of the autonomous aerial vehicle 2 with respect to the flight section in which the remote ID (position information) is not acquired. That is, the confirmation unit 43 may have a function of complementing the flight trajectory of the flight section of the data missing for which the remote ID (position information) has not been acquired. It is conceivable that the remote ID from the autonomous aerial vehicle 2 cannot be acquired due to a failure of a transmitter that transmits the remote ID of the autonomous aerial vehicle 2 or a crash of the autonomous aerial vehicle 2. In such a case, the confirmation unit 43 may estimate the crash position of the autonomous aerial vehicle 2 and the flight position of the autonomous aerial vehicle 2 in a case where the flight of the autonomous aerial vehicle 2 is continued with reference to the standard route pattern (movement pattern) and the flight plan. Since the confirmation unit 43 has such a function, for example, the operation management device 4 can provide the crash position and the continuous flight position of the autonomous aerial vehicle 2 to, for example, the pilot (GCS), it is possible to contribute to quick recovery of the crashed autonomous aerial vehicle 2 and the autonomous aerial vehicle 2 in which the transmitter is out of order.

### Second Example Embodiment

Hereinafter, a second example embodiment according to the present invention will be described. In the description of the second example embodiment, the same reference numerals are given to the components having the same names as those used in the first example embodiment, and redundant description of the components regarding the same names will be omitted.

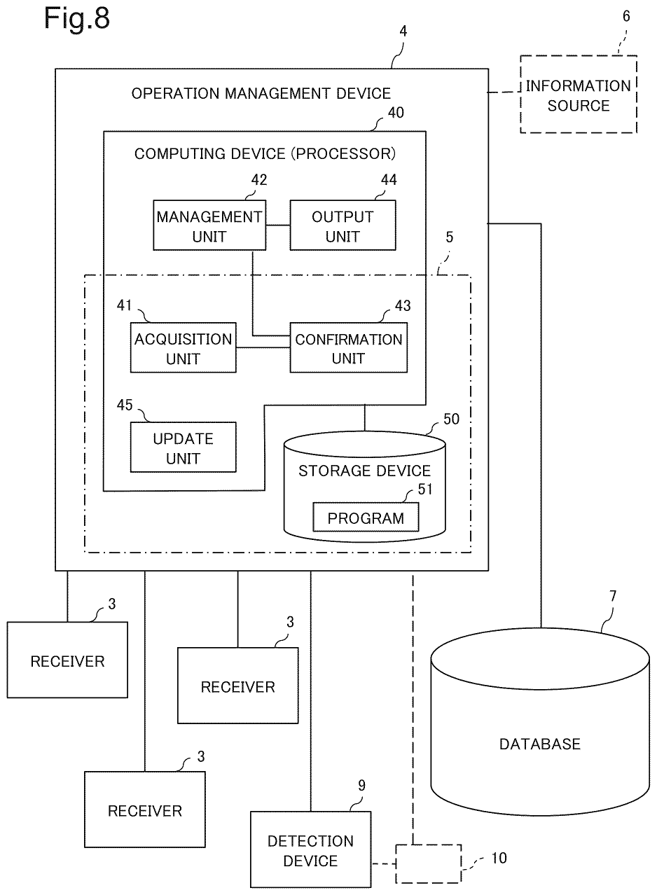

In the second example embodiment, the position calculation device 5 (operation management device 4) includes an update unit 45 as illustrated in FIG. 8 in addition to the configuration of the position calculation device 5 (operation management device 4) of the first example embodiment. The position calculation device 5 (operation management device 4) can acquire information from a detection device 9. The detection device 9 is a device (for example, radar) that detects a flight position of the autonomous aerial vehicle 2, and outputs information indicating the detected flight position (hereinafter, also referred to as a detection position).

Like the acquisition unit 41 and the like, the update unit 45 is a functional unit implemented by the processor executing a program. The update unit 45 calculates an actual flight trajectory (hereinafter, also referred to as a detection trajectory) of the autonomous aerial vehicle 2 by tracking a detection position considered to be of the same autonomous aerial vehicle 2 using the information output from the detection device 9. In a case where the detection trajectory of the autonomous aerial vehicle 2 is calculated by an information processing device 10 different from the position calculation device 5 (operation management device 4) using the information output from the detection device 9, the update unit 45 may acquire the detection trajectory of the autonomous aerial vehicle 2 from the information processing device 10. In this case, the calculation processing of the detection trajectory of the autonomous aerial vehicle 2 by the update unit 45 is omitted.

The update unit 45 further associates the detection trajectory considered to be of the same autonomous aerial vehicle 2 with the estimated trajectory by the confirmation unit 43. The update unit 45 compares the associated detection trajectory with the estimated trajectory, and updates the standard route pattern included in the route reference information by statistical processing or AI using the comparison result.

The configuration of the position calculation device 5 (operation management device 4) according to the second example embodiment other than the above is similar to the configuration of the position calculation device 5 (operation management device 4) according to the first example embodiment.

Since the position calculation device 5 of the second example embodiment has a configuration similar to that of the position calculation device 5 of the first example embodiment, the similar effects to those of the first example embodiment can be obtained. Since the position calculation device 5 of the second example embodiment updates the standard route pattern by the update unit 45, the likelihood of the autonomous aerial vehicle 2 in the standard route pattern can be increased, and thus, the precision of the flight position of the autonomous aerial vehicle 2 confirmed by the confirmation unit 43 can be further increased.

### Other Example Embodiments

The present invention is not limited to the first and second example embodiments, and various example embodiments can be adopted. For example, the first and second example embodiments illustrate examples in which the position calculation device according to the present invention is applied to the operation management device. Alternatively, the position calculation device described in the first and second example embodiments can be applied to, for example, the following monitoring device.

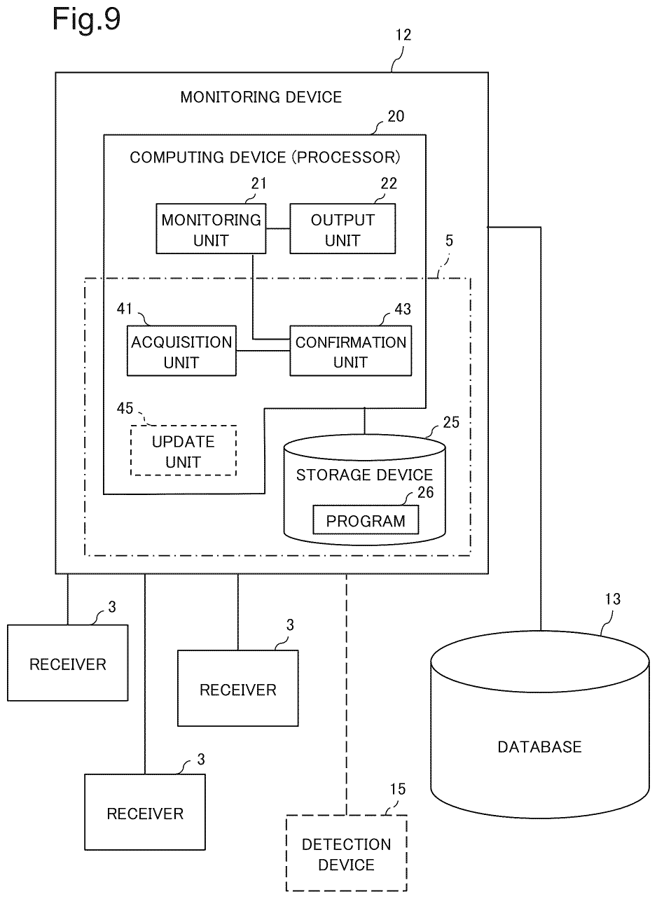

FIG. 9 is a diagram for explaining a configuration of a monitoring device 12 including the position calculation device 5 having a configuration similar to that of the position calculation device 5 described in the first and second example embodiments. The monitoring device 12 is a device that monitors a predetermined monitoring airspace. The monitoring airspace may be set as appropriate, and specific examples thereof include an airspace that requires permission for flight when an autonomous aerial vehicle is caused to fly. More specifically, airspaces that require permission for flight include airspaces above and around important facilities such as airports, power plants, commercial facilities, stadiums, petrochemical complexes, and government facilities. Specific examples of the airspace for which the flight permission is required include a route of an autonomous aerial vehicle such as a logistic-related route for which the flight permission is obtained, and a route (corridor) of an aircraft other than the autonomous aerial vehicle and airspaces around the route.

In order to monitor such a monitoring airspace, a plurality of receivers 3 that receive the remote ID transmitted from the autonomous aerial vehicle 2 are arranged at appropriate positions with intervals therebetween.

The monitoring device 12 includes a computing device 20 and a storage device 25. Similarly to the storage device 50 described in the first and second example embodiments, a storage device 25 includes a storage medium that stores data and a program 26. The computing device 20 includes a processor similarly to the computing device 40 described in the first and second example embodiments, and can have various functions based on the program 26 when the processor executes the program 26. In the example of FIG. 9, the computing device 20 includes an acquisition unit 41 and a confirmation unit 43 constituting the position calculation device 5 described in the first and second example embodiments, and further includes a monitoring unit 21 and an output unit 22. The computing device 20 may include an update unit 45 constituting the position calculation device 5. The functions of the acquisition unit 41, the confirmation unit 43, and the update unit 45 are similar to the functions of the acquisition unit 41, the confirmation unit 43, and the update unit 45 described in the first and second example embodiments.

Here, the description thereof is omitted.

The monitoring unit 21 executes the following monitoring processing using the flight position of the autonomous aerial vehicle 2 confirmed by the confirmation unit 43. For example, flight permission information is generated and stored in advance in the storage device 25 or a database 13 to which the monitoring device 12 is connected. The flight permission information includes information indicating an airplane permitted to fly in the monitoring airspace and its flight plan. In the case of the autonomous aerial vehicle 2, the flight permission information includes unique vehicle body information (that is, the aircraft registration number given by the registration in the country) of the autonomous aerial vehicle 2 permitted to fly in the monitoring airspace and information of a flight plan permitted to fly the autonomous aerial vehicle 2 in association with each other.

When detecting that the flight position of the autonomous aerial vehicle 2 confirmed by the confirmation unit 43 is in the monitoring airspace (that is, entry into the monitoring airspace), the monitoring unit 21 collates the unique vehicle body information included in the remote ID transmitted from the autonomous aerial vehicle 2 with the unique vehicle body information included in the flight permission information. As a result, in a case where the unique vehicle body information of the remote ID is included in the flight permission information, the monitoring unit 21 further refers to the flight plan associated with the unique vehicle body information. As a result, the monitoring unit 21 determines whether the autonomous aerial vehicle 2 flying in the monitoring airspace is the autonomous aerial vehicle 2 permitted to fly in the monitoring airspace, and the flight is in accordance with the flight plan. As a result, in a case where it is determined that the autonomous aerial vehicle 2 permitted to fly in the monitoring airspace is flying according to the flight plan, the monitoring unit 21 continues monitoring the flight in the monitoring airspace of the autonomous aerial vehicle 2, but does not particularly perform other processing related to the autonomous aerial vehicle 2. For example, the output unit 22 outputs information notifying that the autonomous aerial vehicle 2 flying in the monitoring airspace is a permitted aircraft that is permitted to fly toward a monitor viewed by a surveillance staff monitoring the monitoring airspace using the monitoring device 12.

On the other hand, in a case where the unique vehicle body information of the remote ID is not included in the flight permission information, the monitoring unit 21 determines that the autonomous aerial vehicle 2 that has transmitted the remote ID is a suspicious aircraft that is not permitted to fly in the monitoring airspace. The monitoring unit 21 acquires an estimated trajectory by the confirmation unit 43 in the monitoring airspace regarding the unapproved suspicious aircraft (autonomous aerial vehicle 2). Then, the monitoring unit 21 refers to an intrusion purpose determination trajectory provided in advance, and estimates the intrusion purpose of the suspicious aircraft from the acquired estimated trajectory. For example, the monitoring unit 21 estimates that the suspicious aircraft is flying toward a non-public area of the important facility in the monitoring airspace based on the intrusion purpose determination trajectory. Alternatively, in a case where the monitoring unit 21 determines that the target place of the suspicious aircraft in the monitoring airspace cannot be identified even by referring to the intrusion purpose determination trajectory, the monitoring unit estimates that the suspicious aircraft is an autonomous aerial vehicle that has strayed into the monitoring airspace.

Then, the monitoring unit 21 executes coping processing relevant to the estimated intrusion purpose. For example, the monitoring unit 21 notifies, by the output unit 22, a control system (GCS) that is performing flight control of the suspicious aircraft that the suspicious aircraft is to retreat from the monitoring airspace.

The monitoring unit 21 may further execute monitoring processing relevant to an autonomous aerial vehicle that does not transmit a remote ID. For example, the monitoring device 12 is connected to a detection device 15 as indicated by a dotted line in FIG. 9. The detection device 15 is a device that detects an autonomous aerial vehicle in a monitoring airspace, and includes, for example, a passive radar (radio wave detection sensor), a monitoring camera, a radar, a lidar, or a combination of two or more thereof.

The monitoring unit 21 can detect that the autonomous aerial vehicle not transmitting the remote ID is flying in the monitoring airspace by referring to the information on the flight position of the autonomous aerial vehicle 2 confirmed by the confirmation unit 43 and the detection information of the autonomous aerial vehicle in the monitoring airspace acquired from the detection device 15. When detecting that the autonomous aerial vehicle that does not transmit the remote ID, that is, the suspicious aircraft is flying in the monitoring airspace, the monitoring unit 21 executes predetermined coping processing. For example, the monitoring unit 21 calculates the flight trajectory of the suspicious aircraft in the monitoring airspace using the detection information of the autonomous aerial vehicle output from the detection device 15. Then, the monitoring unit 21 compares the calculated flight trajectory of the suspicious aircraft with the planned route included in the flight plan of the autonomous aerial vehicle 2 permitted to fly, and determines whether there is a planned route similar to the flight trajectory of the suspicious aircraft. As a result of this determination, in a case where there is a planned route similar to the flight trajectory of the suspicious aircraft, the monitoring unit 21 determines that the suspicious aircraft is an autonomous aerial vehicle permitted to fly in the monitoring airspace, but the monitoring device 12 (position calculation device 5) has not acquired the remote ID due to occurrence of some kind of failure. In this case, for example, the monitoring unit 21 causes the output unit 22 to output information indicating that the remote ID has not been acquired toward the control system (GCS) that is performing flight control of the autonomous aerial vehicle 2 relevant to the planned route similar to the flight trajectory of the suspicious aircraft. As a result, for example, an operation check of the remote ID transmitter in the autonomous aerial vehicle 2 is executed by the control system (GCS).

In a case where there is no planned route similar to the flight trajectory of the suspicious aircraft, the monitoring unit 21 determines that the suspicious aircraft is an autonomous aerial vehicle not permitted to fly in the monitoring airspace. Then, the monitoring unit 21 executes predetermined coping processing for such a suspicious aircraft. The coping processing in this case includes various processing such as preventing the flight of a suspicious aircraft by laser irradiation or the like, or forcibly landing a suspicious aircraft by controlling a control device (computer) mounted on the suspicious aircraft by hacking. Here, any coping processing may be executed. The monitoring unit 21 may cause the output unit 22 to notify a manager or the like of an important facility relevant to the monitoring airspace that a suspicious aircraft is approaching.

In the description of the above-described example embodiment, an example is illustrated in which the position calculation device 5 is incorporated in the operation management device 4 or the monitoring device 12. On the other hand, the position calculation device 5 may be a single device, and the information on the flight position and the information on the flight trajectory of the autonomous aerial vehicle 2 confirmed by the single position calculation device 5 may be output from the position calculation device 5 to the operation management device and the monitoring device.

In addition to the configuration of the device described in the above-described example embodiment, the position calculation device 5 may have a function of providing the resident or the GCS with information on the flight position of the autonomous aerial vehicle 2 confirmed by the confirmation unit 43. That is, in a case where a terminal device operated by the resident or the GCS is connected to the position calculation device 5 and the terminal device requests the position calculation device 5 to provide information on the flight position of the autonomous aerial vehicle 2, the position calculation device 5 has a function of returning, for example, the flight position of the specific autonomous aerial vehicle 2 or the flight position of the autonomous aerial vehicle 2 flying in a specific airspace in response to the request. The position calculation device 5 may periodically provide the information on the flight position of the autonomous aerial vehicle 2 toward the resident or the terminal device of the GCS registered in advance.

In the above-described example embodiment, the example in which the position calculation device 5 calculates the flight position of the autonomous aerial vehicle 2 has been described, but the method of calculating the position as described above can also be applied to an autonomous vehicle other than the autonomous aerial vehicle, for example, an automatic driving vehicle. In the above-described example embodiment, a standard route pattern (movement pattern) and a flight plan (operation plan) are referred to when selecting a measured position that is likely to be the position of the autonomous aerial vehicle (autonomous vehicle). Alternatively, for example, in the case of an airspace in which a flight plan (operation plan) cannot be referred to for some reason and a route of an autonomous aerial vehicle (autonomous vehicle) is restricted, the flight plan (operation plan) may not be used to select a likely measured position.

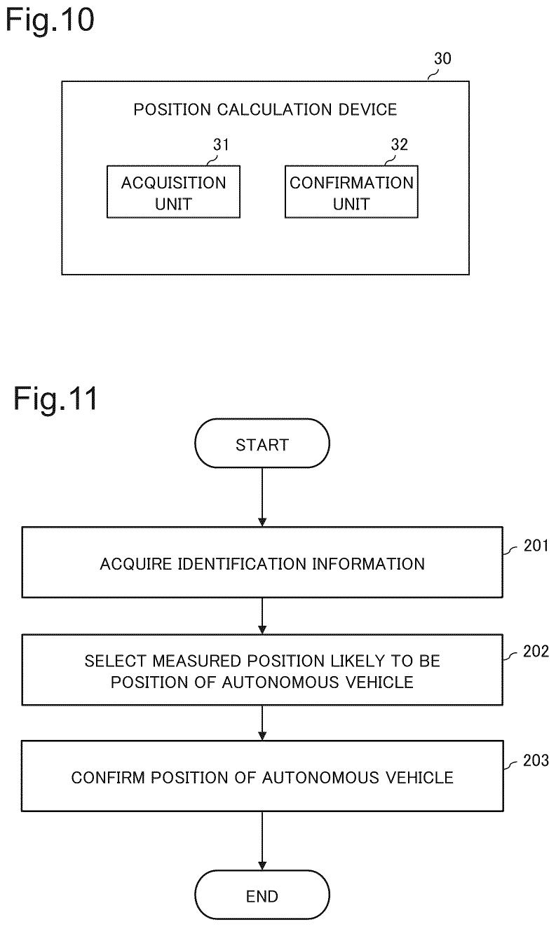

FIG. 10 is a block diagram for explaining a minimum configuration of the position calculation device according to the present invention. A position calculation device 30 in FIG. 10 includes an acquisition unit 31 and a confirmation unit 32. The acquisition unit 31 acquires identification information transmitted at predetermined transmission timings by the autonomous vehicle. The identification information includes unique vehicle body information given to the autonomous vehicle, position information representing the position of the autonomous vehicle, and time information. The confirmation unit 32 uses a predetermined standard movement pattern to select the most likely measured position as the position of the autonomous vehicle from among measured positions, which are the positions of the autonomous vehicle represented by the position information included in each of the plurality of pieces of identification information that have been acquired. The confirmation unit 32 confirms the selected measured position as the position of the autonomous vehicle.

FIG. 11 is a flowchart for explaining an example of the operation related to the calculation of the position of the autonomous vehicle in the position calculation device 30. For example, the acquisition unit 31 of the position calculation device 30 acquires the identification information transmitted from the autonomous vehicle at predetermined transmission timings via, for example, a receiver (step 201 in FIG. 11). Then, the confirmation unit 32 uses a predetermined standard movement pattern to select the most likely measured position as the position of the autonomous vehicle from among measured positions, which are the positions of the autonomous vehicle represented by the position information included in each of the plurality of pieces of identification information that have been acquired (step 202). Then, the confirmation unit 32 confirms the selected measured position as the position of the autonomous vehicle (step 203).

Since the position calculation device 30 confirms the position of the autonomous vehicle by the above-described configuration and operation, it is possible to improve the calculation precision of the position of the autonomous vehicle calculated using the position information transmitted from the autonomous vehicle.

The present invention has been described above using the above-described example embodiments as schematic examples. However, the present invention is not limited to the above-described example embodiments. That is, the present invention can apply various aspects that can be understood by those of ordinary skill in the art without departing from the spirit and scope of the present invention.

### REFERENCE SIGNS LIST

3 receiver
5,30 position calculation device
31, 41 acquisition unit
32, 43 confirmation unit
45 update unit

What is claimed is:

1. A position calculation device comprising:
a memory configured to store instructions; and
at least one processor configured to execute the instructions to:
acquire identification information transmitted from an autonomous vehicle that transmits the identification information at predetermined transmission timings, the identification information including unique vehicle body information given to the autonomous vehicle, position information indicating a position of the autonomous vehicle, and time information; and
select a measured position likely to be a position of the autonomous vehicle using a standard movement pattern provided in advance from among measured positions that are positions of the autonomous vehicle indicated by the position information included in each of a plurality of pieces of the acquired identification information, and confirm the selected measured position as a position of the autonomous vehicle.

2. The position calculation device according to claim 1, wherein the at least one processor is configured to execute the instruction to calculate a movement trajectory of the autonomous vehicle using a plurality of confirmed positions of the autonomous vehicle.

3. The position calculation device according to claim 1, wherein the at least one processor is further configured to execute the instruction to update the standard movement pattern using a detection trajectory that is a movement trajectory of the autonomous vehicle based on a detection position of the autonomous vehicle output from a detection device detecting a position of the autonomous vehicle.

4. The position calculation device according to claim 1, wherein the standard movement pattern is a movement pattern generated using at least one of information of a movement speed of the autonomous vehicle and weather.

5. A position calculation method causing a computer to execute:
acquiring identification information transmitted from an autonomous vehicle that transmits the identification information at predetermined transmission timings, the identification information including unique vehicle body information given to the autonomous vehicle, position information indicating a position of the autonomous vehicle, and time information; and
selecting a measured position likely to be a position of the autonomous vehicle using a standard movement pattern provided in advance from among measured positions that are positions of the autonomous vehicle indicated by the position information included in each of a plurality of pieces of the acquired identification information, and confirming the selected measured position as a position of the autonomous vehicle.

6. A non-transitory program storage medium storing a computer program for causing a computer to execute:
acquiring identification information transmitted from an autonomous vehicle that transmits the identification information at predetermined transmission timings, the identification information including unique vehicle body information given to the autonomous vehicle, position information indicating a position of the autonomous vehicle, and time information; and
selecting a measured position likely to be a position of the autonomous vehicle using a standard movement pattern provided in advance from among measured positions that are positions of the autonomous vehicle indicated by the position information included in each of a plurality of pieces of the acquired identification information, and confirming the selected measured position as a position of the autonomous vehicle.

7. The position calculation method according to claim 5, further causing the computer to execute calculating a movement trajectory of the autonomous vehicle using a plurality of confirmed positions of the autonomous vehicle.

8. The position calculation method according to claim 5, further causing the computer to execute updating the standard movement pattern using a detection trajectory that is a movement trajectory of the autonomous vehicle based on a detection position of the autonomous vehicle output from a detection device detecting a position of the autonomous vehicle.

9. The position calculation method according to claim 5, wherein the standard movement pattern is a movement pattern generated using at least one of information of a movement speed of the autonomous vehicle and weather.

10. The non-transitory program storage medium according to claim 6, further storing a computer program for causing the computer to execute calculating a movement trajectory of the autonomous vehicle using a plurality of confirmed positions of the autonomous vehicle.

11. The non-transitory program storage medium according to claim 6, further storing a computer program for causing the computer to execute updating the standard movement pattern using a detection trajectory that is a movement trajectory of the autonomous vehicle based on a detection position of the autonomous vehicle output from a detection device detecting a position of the autonomous vehicle.

12. The non-transitory program storage medium according to claim 6, wherein the standard movement pattern is a movement pattern generated using at least one of information of a movement speed of the autonomous vehicle and weather.
